(19) United States
(12) Patent Application Publication
(10) Pub. No.: US 2007/0080948 A1
(43) Pub. Date: Apr. 12, 2007

(54) Multi-face button systems and electronic devices and methods using the same

(75) Inventors: Mats Wernersson, Helsingborg (SE); Per Wahlstrom, Malmo (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/293,525

(22) Filed: Dec. 2, 2005

Related U.S. Application Data
(60) Provisional application No. 60/724,011, filed on Oct. 6, 2005.

(51) Int. Cl. G09G 5/00

(52) U.S. Cl. 345/169

(57) ABSTRACT

A button system includes an image sheet including first and second source images, and a screen superimposed on the image sheet such that the image sheet is displayed to a user through the screen. The image sheet and the screen are relatively movable between a first position, wherein the button system displays the first source image to the user, and a second position, wherein the button system displays the second source image to the user.

### RELATED APPLICATION(S)

This application claims the benefit of priority from U.S. Provisional Patent Application No. 60/724,011, filed Oct. 6, 2005, the disclosure of which is incorporated herein by reference in its entirety.

### FIELD OF THE INVENTION

The present invention relates to electronic devices and, more particularly, to electronic devices including control buttons and methods using the same.

### BACKGROUND OF THE INVENTION

As consumer preferences and improved technology result in smaller electronic devices, the space available on electronic devices for keypads and other user input interfaces is increasingly limited. Keypads and touch sensitive screens have been engineered for space efficiency in these environments. However, the functionality and/or ease of use may be compromised in an effort to decrease the size of the user interface.

For example, portable or handheld devices, such as a mobile terminal, may provide various functionalities or operational modes, such as communication, games, and multi-media rendering. To decrease the number of user keys used in a keypad, a particular key may be used in connection with different functionalities depending on the operational mode. For example, in the communication mode, a single key may be used for entering a “1”, whereas the same key in the multi-media mode may be used for initiating a “play” command for rendering multi-media data.

Multifunctional keys may be confusing to a user. Several symbols may need to be provided in a relatively small area. This may be a problem as the physical area available in a portable communication apparatus for each key is limited. As a result, the symbols may be relatively small and difficult to read. Furthermore, it may be difficult to distinguish the symbols from each other and/or be confusing for the user because the functionality of the key may be unclear.

Mobile terminals such as mobile phones also commonly employ “soft keys”, which are a kind of generic key that changes behavior or functionality as various applications are activated. The function associated with a certain key is communicated to the user by changing text in the main display.

It is desirable to instead have keys with text or icons that can change appearance. Several different solutions have been suggested. Most of them rely on LEDs in various colors or other techniques that change the appearance of a button when the light changes. Such solutions may work in dark environments but not in bright daylight.

### SUMMARY OF THE INVENTION

According to embodiments of the present invention, a button system includes an image sheet including first and second source images, and a screen superimposed on the image sheet such that the image sheet is displayed to a user through the screen. The image sheet and the screen are relatively movable between a first position, wherein the button system displays the first source image to the user, and a second position, wherein the button system displays the second source image to the user.

According to some embodiments, the button system further includes a button activator underlying the image sheet.

According to some embodiments, the screen includes a lens screen adapted to convert the first and second source images as displayed to the user into first and second displayed images, the first and second displayed images being different from the first and second source images. The lens screen may include at least one prism. According to some embodiments, the prism has a radius of curvature of no more than 0.1 mm. The lens screen may be a lenticular lens. According to some embodiments, the first source image includes a plurality of first image segments having first voids therebetween, and the first voids are reduced in the first displayed image as compared to the first source image. According to some embodiments, the second source image includes a plurality of second image segments having second voids therebetween and being interposed between the first image segments, and the second voids are reduced in the second displayed image as compared to the second source image.

The button system may further include a mask pattern on the screen adapted to hide the second source image when the button system is in the first position.

The button system may further include an actuator operable to move at least one of the image sheet and the screen between the first position and the second position, and a controller operative to control the actuator.

According to some embodiments, the first and second positions correspond to first and second different operational modes of an associated electronic device.

According to further embodiments of the present invention, an electronic device includes a button system. The button system includes an image sheet including first and second source images, and a screen superimposed on the image sheet such that the image sheet is displayed to a user through the screen. The image sheet and the screen are relatively movable between a first position, wherein the button system displays the first source image to the user, and a second position, wherein the button system displays the second source image to the user.

According to some embodiments, the electronic device further includes a button activator underlying the image sheet.

According to some embodiments, the screen includes a lens screen adapted to convert the first and second source images as displayed to the user into first and second displayed images, the first and second displayed images being different from the first and second source images. The lens screen may be a lenticular lens.

According to some embodiments, the first and second positions correspond to first and second different operational modes of an associated electronic device.

The electronic device may be a wireless communications device. The electronic device may be a handheld wireless communications device.

According to method embodiments of the present invention, a method for providing a multi-face button using a button system including an image sheet and a screen superimposed on the image sheet such that the image sheet is displayed to a user through the screen, the image sheet including first and second source images, includes relatively moving the image sheet and the screen from a first position, wherein the button system displays the first source image to the user, and a second position, wherein the button system displays the second source image to the user.

The method may further include pressing the screen to actuate a button activator.

The method may further include thereafter relatively moving the image sheet and the screen from the second position to the first position to again display the first source image to the user.

According to some embodiments, the method includes switching from a first operational mode of an associated electronic device to a second, different operational mode of an associated electronic device.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is an exploded, perspective view of a button system according to embodiments of the present invention.

FIG. 2 is a schematic, partial side view of the button system of FIG. 1 in a first position, wherein the button system displays a first displayed image according to embodiments of the invention.

FIG. 3 is a further schematic, partial side view of the button system of FIG. 1 in the first position illustrating viewing from another angle.

FIG. 4 is a schematic, partial side view of the button system of FIG. 1 in a second position, wherein the button system displays a second displayed image according to embodiments of the invention.

FIG. 5 is a front view of a merged source image on an image sheet of the button system of FIG. 1 in accordance with embodiments of the present invention.

FIG. 6 is a front view of the first displayed image of the button system of FIG. 1.

FIG. 7 is a front view of the second displayed image of the button system of FIG. 1.

FIG. 8 is a schematic, partial side view of the button system of FIG. 1 modified to further include a mask according to embodiments of the present invention.

FIG. 9 is a schematic diagram of a mobile terminal according to embodiments of the present invention and an exemplary base station transceiver.

FIG. 10 is a schematic front view of the mobile terminal of FIG. 9 wherein the button system is in the first position.

FIG. 11 is a schematic front view of the mobile terminal of FIG. 9 wherein the button system is in the second position.

FIG. 12 is a partial, cross-sectional view of the mobile terminal of FIG. 9 taken along the line 12-12 of FIG. 10.

FIG. 13 is an enlarged, partial, cross-sectional view of the mobile terminal of FIG. 9 taken along the line 13-13 of FIG. 10.

FIG. 14 is a front view of a merged source image on an image sheet of a button system according to further embodiments of the present invention.

FIG. 15 is a front view of a first displayed image of the button system of FIG. 14.

FIG. 16 is a front view of a second displayed image of the button system of FIG. 14.

FIG. 17 is a front view of a third displayed image of the button system of FIG. 14.

### DETAILED DESCRIPTION OF EMBODIMENTS OF THE INVENTION

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the term “comprising” or “comprises” is open-ended, and includes one or more stated features, integers, elements, steps, components or functions but does not preclude the presence or addition of one or more other features, integers, elements, steps, components, functions or groups thereof.

As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In addition, spatially relative terms, such as “under”, “below”, “lower”, “lover”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Furthermore, “coupled” or “connected” as used herein may include wirelessly coupled or connected.

Well-known functions or constructions may not be described in detail for brevity and/or clarity.

As used herein, “electronic component” means an active device as contrasted with a passive electrical connector or the like. An electronic component may include a processor.

As used herein, a “communication terminal” includes, but is not limited to, a terminal that is configured to receive/transmit communication signals via a wireline connection, such as via a public-switched telephone network (PSTN), digital subscriber line (DSL), digital cable, or another data connection/network, and/or via a wireless interface with, for example, a cellular network, a satellite network, a wireless local area network (WLAN), and/or another communication terminal.

When the communication terminal is configured to communicate over a wireless interface, it is referred to herein as a “wireless communication terminal” or a “wireless terminal.” Examples of wireless terminals include, but are not limited to, a cellular telephone, personal data assistant (PDA), pager, and/or a computer that is configured to communicate data over a wireless communication interface that can include a cellular telephone interface, a Bluetooth interface, a wireless local area network interface (e.g., 802.11), another RF communication interface, and/or an optical/infra-red communication interface.

As used herein, “mobile terminals” may be portable, transportable, installed in a vehicle (aeronautical, maritime, or land-based), or situated and/or configured to operate locally and/or in a distributed fashion at any other location(s) on earth and/or in space.

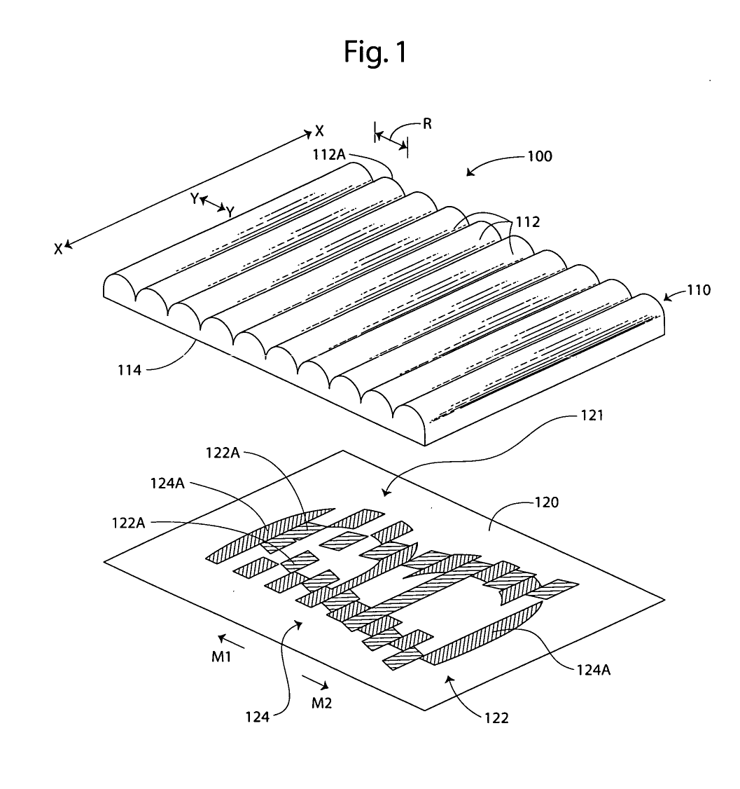

Embodiments of the present invention will now be described below with respect to FIGS. 1-17. Embodiments of the present invention provide multi-face button systems and electronic devices incorporating multi-face button systems. Each multi-face button is configured to alternatively display each of a first display image and a second display image on a button. The first and second display images may correspond to and be displayed in tandem with first and second operational modes of the electronic device (e.g., a phone mode and a camera mode). According to some embodiments, the electronic device is a mobile terminal.

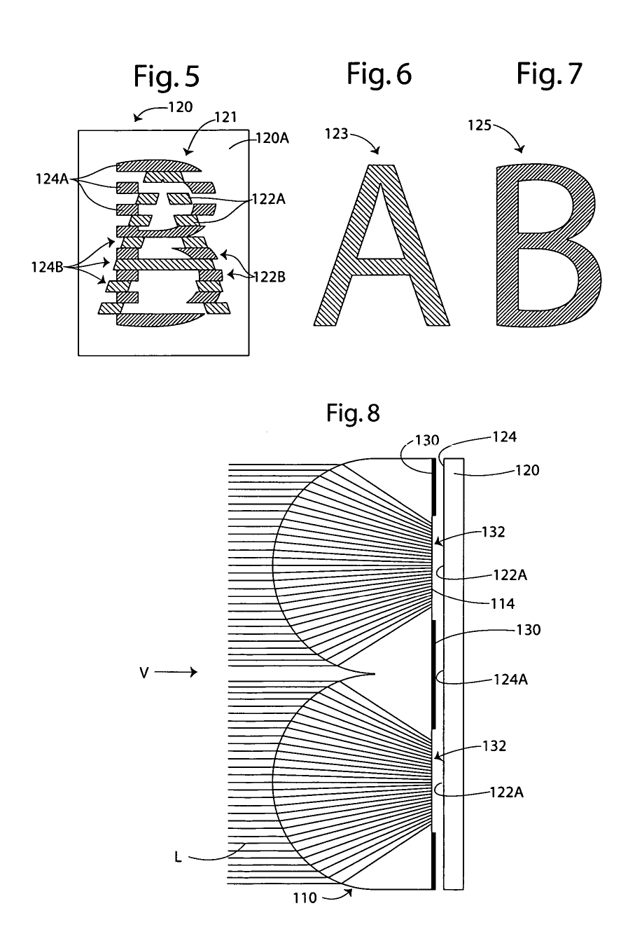

Embodiments of the present invention are illustrated in FIG. 1, wherein a dual-or multi-face button system 100 is shown. The button system 100 includes an optical or lens screen 110 made of a translucent or transparent material having a plurality of prisms 112. The system 100 further includes an image sheet 120 with two source images 122 and 124 provided thereon as printed symbols. For example, for the purposes of illustration, the first source image 122 may consist of spaced apart image segments 122A generally forming a letter “A” pattern and the second source image 124 may consist of spaced apart image segments 124A generally forming a letter “B” pattern. The image segments 122A, 124A are interdigitated to form a merged or combined source image 121 on the image sheet 120. The combined source image 121 (as it appears directly on the image sheet 120 without looking through the screen 110) is also shown in FIG. 5.

The image sheet 120 is preferably in close contact with the screen 110. The image sheet 120 may be backlit and/or reflective. The screen 110 and the sheet 120 may be positioned over a button mechanism (e.g., an electromechanical contact pad or switch) such that pressing the screen 110 serves to actuate the button. A further member such as a button cover member may be positioned over the screen 110 so that the user contacts the button cover member when pressing the button.

The prisms 112 extend generally parallel to a prism axis X-X (FIG. 1). The prism axis X-X is transverse to (and, according to some embodiments, substantially perpendicular to) a movement or slide axis Y-Y. The image segments 122A and 124A are interdigitated or alternate along the slide axis Y-Y and generally extend lengthwise parallel to the prism axis X-X.

The image sheet 120 may include a background portion 120A (FIG. 5) that surrounds and provides a contrast with the source images 122, 124. For example, the background portion 120A may be opaque and the source images 122, 124 may be translucent or transparent so that a greater amount of the backlighting is transmitted through the source images 122, 124 than the background portion 120A. Alternatively, the source images 122, 124 may be relatively opaque compared to the background portion 120A. Alternatively, or additionally, the background portion 120A may have a color that contrasts with the color(s) of either or both of the source images 122, 124. While the image segments 122A and 124A are differently shaded for the purposes of explanation, it will be appreciated that they may have the same or different color and/or opacity characteristics.

The lens screen 110 and image sheet 120 may each be formed of any suitable material such as a glass or polymeric material. The source images 122, 124 and/or the background portion 120A may be provided on the image sheet 120 by any suitable method. For example, the source images 122, 124 may be deposited or printed on a surface of the image sheet or defined by portions omitted or removed (e.g., etched) from a printed layer forming the background portion 120A. By way of further example, the source images may be portions or members embedded in the image sheet 120.

According to some embodiments, the screen 110 has a thickness T1 (FIG. 3) in the range of from about 0.1 to 0.3 mm. According to some embodiments, the image sheet 120 has a thickness T2 (FIG. 3) in the range of from about 0.1 to 0.3 mm.

According to some embodiments, the prisms 112 of the screen 110 are semi-cylindrical. According to some embodiments, the pitch of the screen is quite dense in order to achieve a good resolution. According to some embodiments, a pitch of between about 0.1 and 0.2 mm is provided.

In accordance with methods of the present invention, the sheet 120 can be positioned in a first position to display the first source image 122 through the screen 110 to a user on the screen side of the button system 100. The image sheet 120 can then be shifted or moved sideways along the slide axis Y-Y (as indicated by the arrow M1 in FIG. 1) relative to the screen 110 into a second position to display the second source image 124 through the screen 110 to a user. According to some embodiments, the image sheet 120 is moved a distance of approximately the radius R of the curves 112A of the prisms 112 of the screen 110. The image sheet 120 can then be moved sideways in the opposite direction along the slide axis Y-Y (as indicated by the arrow M2 in FIG. 1) relative to the screen 110 back into the first position to display the first source image 122 again.

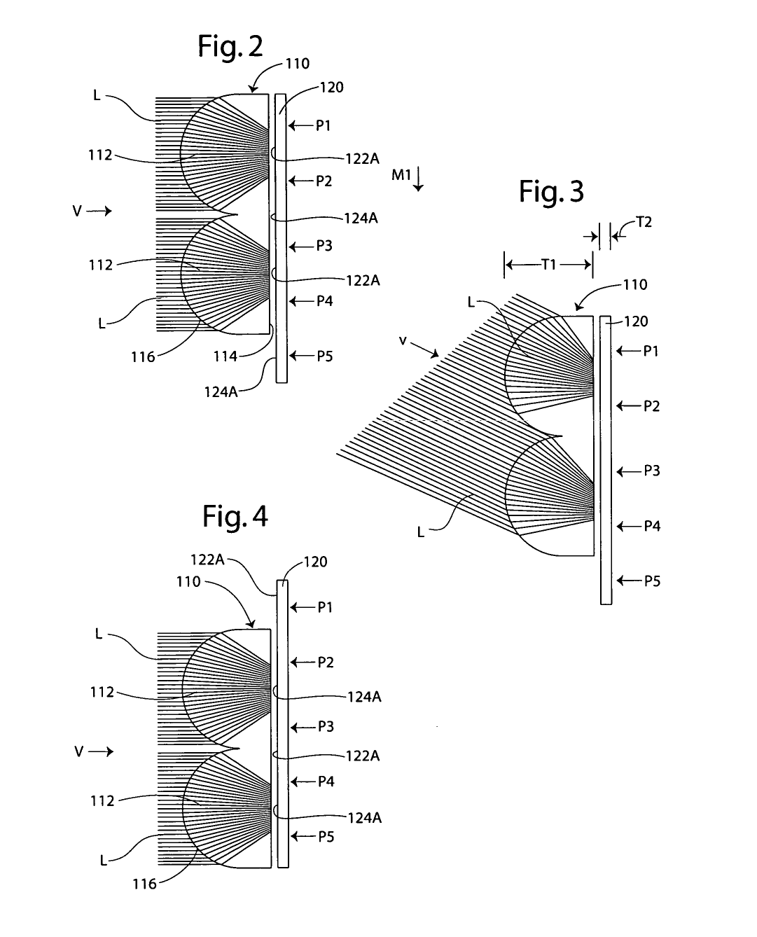

FIGS. 2-4 further illustrate the operation of the button system 100 and show schematic side views or cross-sectional views of two adjacent prisms 112 of the screen 110. The viewing user would be positioned on the left side of the screen 110 and the image sheet 120 would be positioned on the right side with the viewer looking at the system 100 in a direction V. Bundles of light rays from the image sheet 120 (from a backlighting source or reflection) are transmitted through the screen 110 from the back surface 114 toward the front surface 116 (i.e., right to left) and are refracted by the prisms 112 as shown. The prisms 112 may thereby serve to collimate (in part or in full) the light bundles L and enlarge the cross-sectional area of the light bundles L as shown.

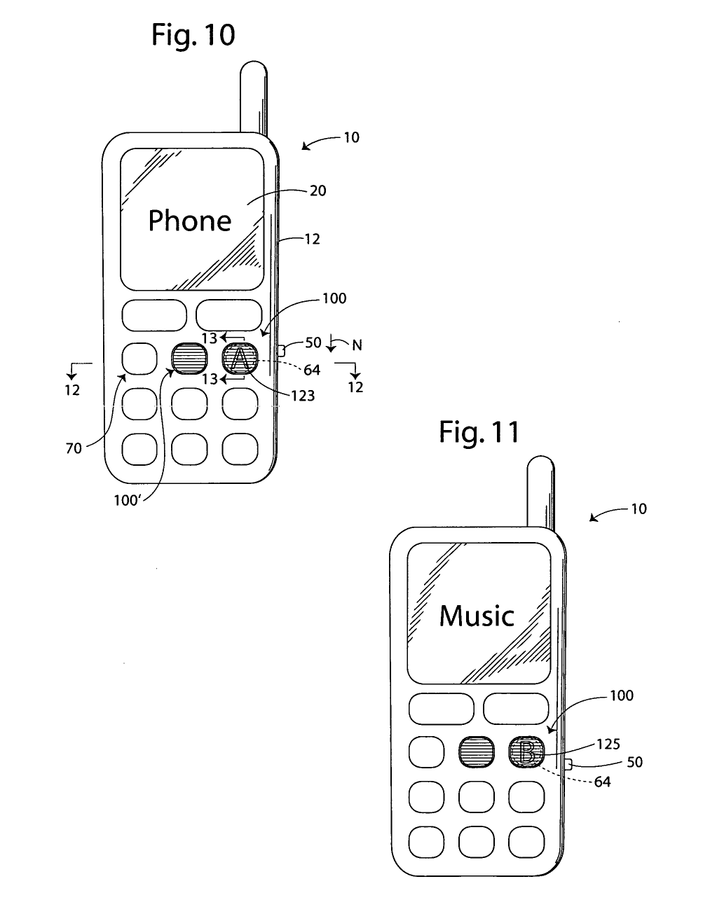

In a first position as shown in FIG. 2, the user will only see the portions of the sheet 120 between locations P1 and P2 and between locations P3 and P4. Image segments 122A are disposed in these locations. The portions of the sheet 120 between locations P2 and P3 and between locations P4 and P5 are not visible. Image segments 124A are disposed in these locations. FIG. 3 shows that this is the case also when the user views the button system 100 at a relatively steep angle. In the first position, a displayed image 123 will appear to the user through the screen 110 as shown in FIGS. 6 and 10. The displayed image 123 forms the letter “A”, and corresponds to the source image 122 except that certain spaces or voids in the pattern of the source image 122 are eliminated as will be appreciated by comparison of FIGS. 5 and 6. The prisms 112 serve to refract the image segments 122A so that the spaces or voids 122B (FIG. 5) therebetween are reduced or eliminated in the displayed image 123.

The user then slides the sheet 120 in the direction M1 relative to the screen 110 (and/or slides the screen 110 in the opposite direction) to the second position as shown in FIG. 4. In the position as shown in FIG. 4, the user will only see the portions of the sheet 120 between locations P2 and P3 and between locations P4 and P5. The portions of the sheet 120 between locations P1 and P2 between locations P3 and P4 are not visible. In the second position, a displayed image 125 will appear to the user through the screen 110 as shown in FIGS. 7 and 11. The displayed image 125 forms the letter “B”, and corresponds to the source image 124 except that certain spaces of the source image 124 are eliminated as will be appreciated by comparison of FIGS. 5 and 7. The prisms 112 again serve to refract the image segments 124A so that spaces or voids 124B (FIG. 5) therebetween are reduced or eliminated in the displayed image 125. The button system 100 can be returned to the first position to again display the displayed image 123 by sliding the image sheet 120 in the direction M2 relative to the screen 110 (and/or sliding the screen 110 in the opposite direction).

Thus, the sheet 120 can be designed in such a way that image segments 122A forming one symbol (or other image) are present between locations P1 and P2 and between locations P3 and P4, and image segments 124A forming another symbol are present between locations P2 and P3 and between locations P4 and P5. By shifting the position of the sheet 120 relative to the overlying screen 110, it is possible to change or alternate between two symbols or other patterns visible to the user.

Moreover, the prisms 112 may serve to modify the source image 122,124 so that a more preferred displayed image 123, 125 is provided. For example, as illustrated, the prisms 112 convert the spaced apart segments 122A, 124A into solid images of “A” and “B”.

According to some embodiments, the image sheet 120 is moved between the first and second positions a distance of about 0.5 times the pitch size. Thus, only a small mechanical movement is necessary, which may facilitate construction and operation of the button system 100. The image sheet 120 and the screen 110 can be relatively moved using any suitable method or mechanism. Either or both of the image sheet 120 and the screen 110 can be moved relative to a common structure (e.g., a device housing). For example, a lever or other mechanism can be coupled to the sheet 120 and/or the screen 110 such that when the lever is moved it causes relative movement between the sheet 120 and the screen 110. This same lever or the like may also be used to switch between operational modes of a device so that the displayed button images correspond to the respective selected modes.

The button system may comprise a group of keys or buttons. For example, an image sheet may cover the area of a group of keys and be movable using a single mechanical or electromechanical device or mechanism. A group of keys may, for example, be switched between music or sound player keys (with corresponding symbols) and generic phone keys (with corresponding symbols).

The image sheet 120 may be made of a semi-transparent or translucent material allowing keyboard LEDs or other backlighting to shine through. In that case, it will be clearly visible in bright environments as well as in the dark.

Embodiments of the present invention can provide a compact and cost-effective solution to the problem of dual face buttons. The button system may work effectively under both light and dark conditions.

The screen employed (e.g., the screen 110) may be a lens screen of the type commonly referred to as a lenticular screen. Such screens have been used for creating 3D images and images that change appearance when the user tips it.

According to embodiments of the invention, the lenticular screen of the button system differs from that of some conventional lenticular screens. A lenticular screen is usually designed to show different images depending on the viewing angle. For stereoscopic imaging, this effect is used to direct one image to the left eye and another image to the right eye of the viewer. In other applications, multiple images are located under the screen and the viewer will see different images as the viewer tips the image, viewing it from different directions. The lens curvature has a relatively large radius in order to achieve this effect.

According to embodiments of the invention, the lenticular screen of the present invention differs in this aspect. The lens radius is made much shorter. The effect of the inventive lenticular screen will then be generally opposite that of the typical 3D-device screen. Instead of showing different, images depending on the viewing angle, the same image is shown regardless of the viewing angle (at least within a prescribed range of viewing angles). A portion of the image sheet bearing the images is hidden from the user regardless of the viewing angle. The only way of showing the hidden portion is to move the image sheet relative to the lenticular screen. According to some embodiments, the lens radius R (i.e., the radius of curvature of each prism 112) of the screen 110 is no more than 0.1 mm and, according to some embodiments, between about 0.05 and 0.15 mm.

According to further embodiments of the invention and with reference to FIG. 8, an opaque mask 130 may be printed on the flat surface 114 of the lenticular screen 110. According to further embodiments of the invention, the mask 130 has the same color as the background of the sheet 120 surrounding the source images 122, 124. In a given position, the mask 130 obfuscates, hides or covers the image segments of one source image and the image segments of the other source image are exposed through openings 132 in the mask 130. For example, in the first position, the mask 130 covers the image segments 124A of the hidden source image 124 but image segments 122A of the non-hidden source image 122 are exposed through the openings 132 in the mask 130. The mask 130 may serve to compensate for imperfections in the lenticular screen 110 due to the manufacturing process that might otherwise cause some light rays from the hidden image to escape through the screen. Some internal reflections in the screen may also mix some light rays from the two source images. This may be disturbing if the two source images are of different colors.

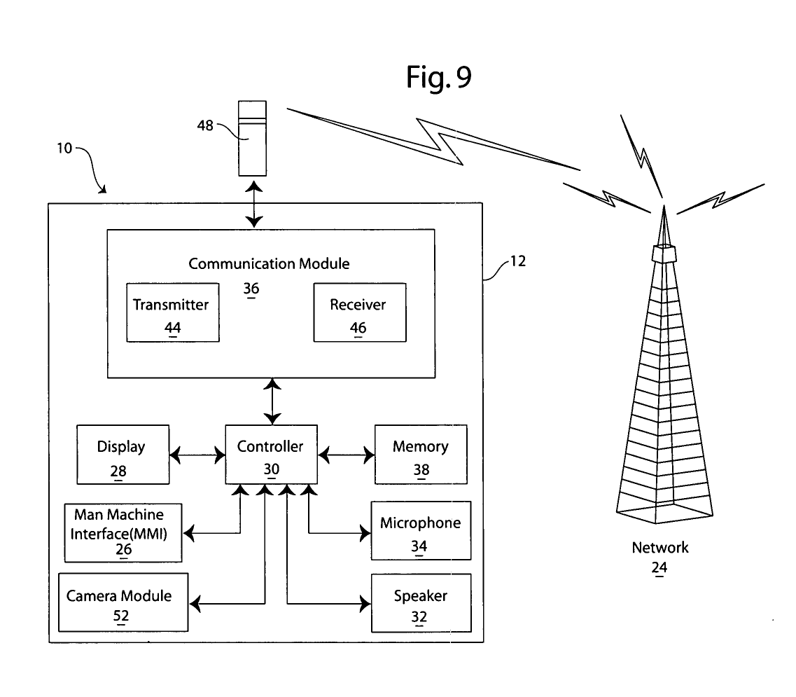

Button systems of the present invention may be incorporated into an electronic device such as a communication terminal. According to some embodiments, the button system is incorporated into a mobile communication terminal. According to some embodiments, the button system is incorporated into a wireless communication terminal such as a cellular telephone, which may be a mobile wireless communication terminal. In particular, the mobile terminal may be a handheld terminal. An exemplary mobile wireless communication terminal 10 including the button system 100 is shown in FIGS. 9-13.

Referring now to FIG. 9, an exemplary radiotelephone communication system in accordance with embodiments of the present invention is illustrated, which includes the mobile wireless communication terminal 10 and a base station transceiver, which is part of a wireless communications network 24. In some embodiments of the present invention, the network 24 includes a base station transceiver that includes the radio transceiver(s) that define an individual cell in a cellular network and communicates with the mobile terminal 10 and other mobile terminals in the cell using a radio-link protocol. It will be understood that, in some embodiments of the present invention, many base station transceivers may be connected through, for example, a mobile switching center and other devices to define a wireless communications network.

The mobile terminal 10 includes a portable housing assembly 12 and a man machine interface (MMI) 26. The mobile terminal 10 also includes a display 28, a speaker 32, a microphone 34, a transceiver or communication module 36, and a memory 38 including application information and parameters, any of which may communicate with a processor or controller 30. Furthermore, the mobile terminal 10 according to embodiments of the present invention may further include a digital camera module 52, which also communicates with the controller 30. Other user interface devices may be provided such as other suitable input device(s).

The speaker 32 generates sound responsive to an input audio signal. The microphone 34 is coupled to an audio processor that is configured to generate an audio data stream responsive to sound incident on the microphone. The display 28 may be, for example, a liquid crystal display (LCD).

The communication module 36 can include a cellular communication module, a direct point-to-point connection module, and/or a WLAN module. With a cellular communication module, the wireless terminal 10A can communicate via the base station(s) of the network using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations may be connected to a Mobile Telephone Switching Office (MTSO) wireless network, which, in turn, can be connected to a PSTN and/or another network.

The communication module 36 may include a transceiver typically having a transmitter circuit 44 and a receiver circuit 46, which respectively transmit outgoing radio frequency signals (e.g., to the network 24, a router or directly to another terminal) and receive incoming radio frequency signals (e.g., from the network 24, a router or directly from another terminal), such as voice and data signals, via an antenna 48. The communication module 36 may include a short-range transmitter and receiver, such as a Bluetooth transmitter and receiver. The antenna 48 may be an embedded antenna, a retractable antenna or any antenna known to those having skill in the art without departing from the scope of the present invention. The radio frequency signals transmitted between the mobile terminal 10 and the network 24 may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, the transceiver may include an infrared (IR) transceiver configured to transmit/receive infrared signals to/from other electronic devices via an IR port.

The controller 30 may support various functions of the mobile terminal 10. The controller 30 can be any commercially available or custom microprocessor, for example. In use, the controller 30 of the mobile terminal 10 generates a display image on the display 28. The controller 30 also transitions between and operates different operational modes of the mobile terminal 10 (e.g., a phone mode, a music playback mode, a camera mode, etc.) as discussed herein. The controller 30 is operatively connected to a button activator 64 as discussed below.

The foregoing components of the mobile terminal 10 may be included in many conventional mobile terminals and their functionality is generally known to those skilled in the art. As used herein, the term “portable electronic device” or “mobile terminal” may include: a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; a gaming device, an audio video player, and a conventional laptop and/or palmtop portable computer that may include a radiotelephone transceiver.

According to some embodiments and as illustrated in FIGS. 10 and 11, the mobile terminal 10 is a handheld (portable) mobile terminal. By “handheld mobile terminal,” it is meant that the outer dimensions of the mobile terminal are adapted and suitable for use by a typical operator using one hand. According to some embodiments, the total volume of the handheld mobile terminal is less than about 200 cc. According to some embodiments, the total volume of the handheld terminal is less than about 100 cc. According to some embodiments, the total volume of the handheld mobile terminal is between about 50 and 100 cc. According to some embodiments, no dimension of the handheld mobile terminal 10 exceeds about 200 mm.

The housing 12 defines an interior cavity 12A and has a front wall 12B. Button openings 12C are defined in the front wall 12B. The housing 12 may be formed of a polymeric material, such as polystyrene. Alternatively or additionally, the housing 12 may be formed of any other suitable material, such as metal. The housing 12 may be molded and may be assembled from multiple parts. While the mobile terminal 10 as shown is of a generally one-piece design, it is also contemplated that it may include two or more subhousings joined by a hinge or other suitable mechanism(s) to allow for relative movement between the housings. For example, the mobile terminal 10 may include a pair of subhousings hinged to form a clamshell housing. Handheld wireless communication terminals having clamshell housings are commonly referred to as “flip phones.”

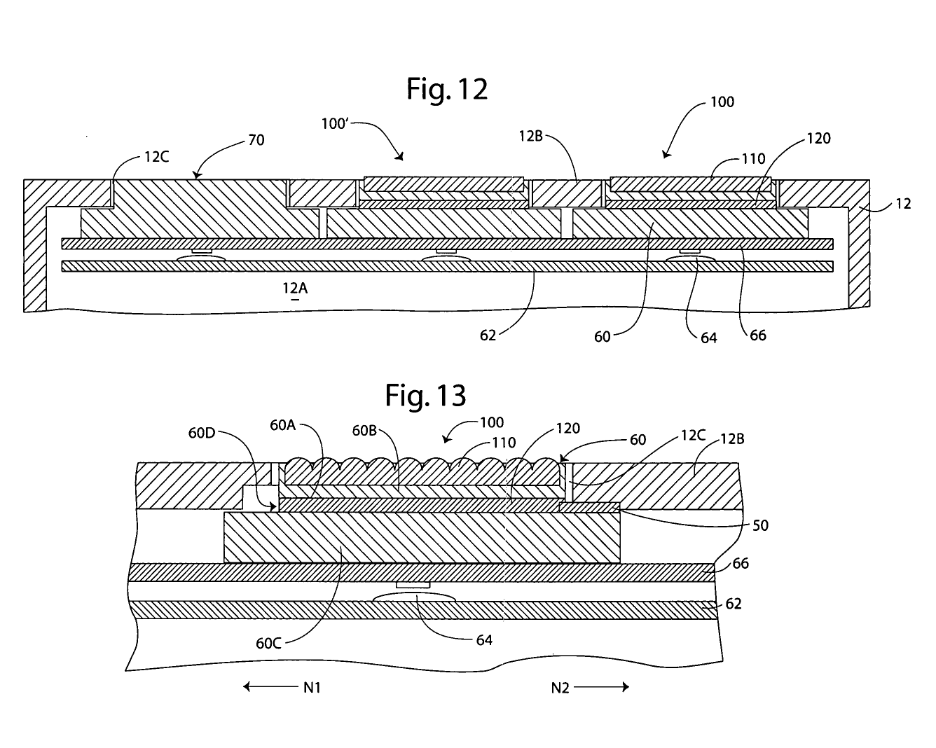

Referring to FIGS. 12 and 13, the MMI 26 also includes the button system 100 and an associated button activator 64. As shown in FIG. 13, the screen 110 and the sheet 120 are mounted on a button member or hard top 60 in or adjacent the button opening 12C. The button member 60 includes a top portion 60B, a base portion 60C, a cavity 60A defined in the top portion 60B, and a slot 60D defined between the top portion 60B and the base portion 60C. The screen 110 is secured in the cavity 60A. The sheet 120 is slidably mounted in the slot 60D for slidable movement in opposed directions N1 and N2 relative to the screen 110. At least the top portion 60B is formed of a transparent or translucent material so that the sheet 120 is viewable through the screen 110 and the top portion 60B. A mode selection lever 50 (FIGS. 10, 11 and 13) is joined to the sheet 120 for sliding the sheet 120 in the button member 60.

The base portion 60C is mounted on a flexible rubber pad 66, which overlies a keypad printed circuit board 62. A button activator 64 such as a dome switch is mounted on the board 62 below the button member 60.

In use, the user may press the screen 110 in normal fashion for operation of a button. When a sufficient force is applied to the screen 110, the button activator 64 is activated to provide a signal or other indication to an electronic device (e.g., the controller 30) indicating that a user has selected the button. For example, the button activator 64 may be a key of a keypad that is operatively connected to an associated logic circuit that generates an electrical signal responsive to and corresponding to the actuation of the button activator 64.

Referring to FIG. 10, the terminal 10 is shown in a first selected mode such as a phone mode. The mode selection lever 50 is in a corresponding first position. The sheet 120 is positioned in the first position such that the first source image 122 is displayed to the user in the button system 100 as the first displayed image 123. When the user wishes to change the terminal 10 to a second mode, such as a sound or music player mode, the user slides the lever 50 to a second position as indicated by the arrow N1 and shown in FIG. 10. As discussed above, sliding the lever 50 moves the sheet 120 relative to the screen 110 so that the second source image 124 is displayed to the user in the button system 100 as the second displayed image 125 (FIG. 11). The user may slide the lever 50 back in the direction N2 to return to the first position, thereby returning the terminal 10 back to the first mode and causing the button system 100 to again display the displayed image 123.

The repositioning of the lever 50 also actuates the controller 30 to change from the first mode to the second mode of the terminal 10. The button activator 64 can be actuated in either mode (e.g., by pressing the button system 100), and such actuation will in turn actuate the controller 30 in accordance with the current mode. That is, the operation triggered by the button activator 64 may be different for each mode. According to some embodiments, the change in operational modes of the terminal 10 occurs substantially simultaneously with the change between the corresponding displayed images 123, 125.

According to some embodiments, the controller 30 may control an actuator 52 (e.g., an electric motor) that slides the image sheet 120 relative to the screen 110. The controller 30 may automatically actuate the actuator 52 to move the sheet 120 responsive to activation/change of modes of the mobile terminal 10 or other device, thereby automatically changing the button display to correspond to the selected mode.

The screen 110 may serve as the contact surface for the user to actuate the button activator 64. Alternatively, a button cover member may overlie the screen 110, in which case the user will press on the button cover member in order to actuate the button activator 64.

The button system 100 may include multiple buttons or keys. For example, other buttons 100′ of the terminal 10 may include a screen and image sheet as described herein. The multiple buttons may use respective portions of the same screen 110 and/or image sheet 120 or each use respective different screens and/or image sheets. In the latter case, some or all of the different screens or image sheets may be ganged or interconnected so that they are moved together. For example, sliding the lever 50 as discussed above may serve to change the image displayed on two or more of the keys of the terminal 10. The terminal 10 may include further buttons 70 that are not multi-face buttons as described herein. Button systems of the present invention may be incorporated into buttons other than keypad buttons, as well.

Although the electronic devices are discussed herein as being included as part of a mobile wireless communication terminal, for example, the mobile terminal 10 of FIGS. 9-13, embodiments of the present invention are not limited to this configuration. Various aspects of the present invention may be incorporated into other types of devices including, for example, mobile devices that are not wireless communication terminals or non-portable electronic devices, without departing from the scope of the present invention.

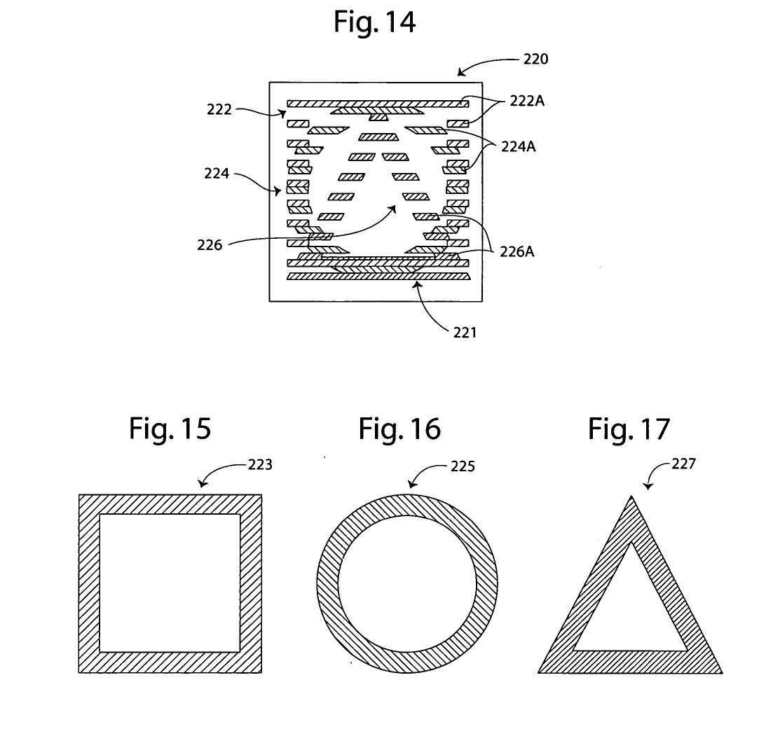

According to further embodiments of the present invention, button systems as described herein may be adapted to display more than two alternate displayed images. For example, with reference to FIGS. 14-17, the button system 100 may include an image sheet 220 in place of the sheet 120 so that the button system 100 is capable of displaying each of three alternative displayed images 223, 225, 227. The button system 100 may be otherwise constructed in the same manner as described above. Alternatively, the button system may be modified (e.g., with a modified lens screen in place of the screen 110) to accommodate the image sheet 220.

Referring to FIG. 14, the image sheet 220 includes a first source image 222 consisting of spaced apart image segments 222A generally forming a square, a second source image 224 consisting of spaced apart image segments 224A generally forming a circle, and a third source image 226 consisting of spaced apart image segments 226A generally forming a triangle. The image segments 222A, 224A, 226A are sequentially interdigitated to form a combined source image 221.

The modified button system may be used in the same manner as described above except that the lens screen 110 and the sheet 220 can be selectively positioned in each of three alternative positions to alternatively display each of the three respective displayed images 223, 225, 227. Referring also to FIG. 2, when in the first position, the segments 224A, 226A are positioned between points P2 and P3 and between points P4 and P5 so that they are not displayed, and the segments 222A are positioned between points P1 and P2 and between points P3 and P4 so that they are displayed as the displayed image 223 (FIG. 15). When in the second position, the segments 222A, 226A are positioned between points P2 and P3 and between points P4 and P5 so that they are not displayed, and the segments 224A are positioned between points P1 and P2 and between points P3 and P4 so that they are displayed as the displayed image 225 (FIG. 16). When in the third position, the segments 222A, 224A are positioned between points P2 and P3 and between points P4 and P5 so that they are not displayed, and the segments 226A are positioned between points P1 and P2 and between points P3 and P4 so that they are displayed as displayed image 227 (FIG. 17).

The modified button system may be operated to return to each of the three positions as desired. Button systems according to embodiments of the invention may be modified to display more than three alternative displayed images, as well.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

We claim:

1. A button system comprising:
an image sheet including first and second source images; and
a screen superimposed on the image sheet such that the image sheet is displayed to a user through the screen;
wherein the image sheet and the screen are relatively movable between a first position, wherein the button system displays the first source image to the user, and a second position, wherein the button system displays the second source image to the user.

2. The button system of claim 1 including a button activator underlying the image sheet.

3. The button system of claim 1 wherein the screen includes a lens screen adapted to convert the first and second source images as displayed to the user into first and second displayed images, the first and second displayed images being different from the first and second source images.

4. The button system of claim 3 wherein the lens screen includes at least one prism.

5. The button system of claim 4 wherein the radius of curvature of each prism is no more than about 0.1 mm.

6. The button system of claim 4 wherein the lens screen is a lenticular lens.

7. The button system of claim 6 wherein:
the first source image includes a plurality of first image segments having first voids therebetween; and
the first voids are reduced in the first displayed image as compared to the first source image.

8. The button system of claim 7 wherein:
the second source image includes a plurality of second image segments having second voids therebetween and being interposed between the first image segments; and
the second voids are reduced in the second displayed image as compared to the second source image.

9. The button system of claim 1 including a mask pattern on the screen adapted to hide the second source image when the button system is in the first position.

10. The button system of claim 1 including:
an actuator operable to move at least one of the image sheet and the screen between the first position and the second position; and
a controller operative to control the actuator.

11. The button system of claim 1 wherein the first and second positions correspond to first and second different operational modes of an associated electronic device.

12. The button system of claim 1 wherein:
the image sheet includes a third source image; and
the image sheet and the screen are relatively movable to a third position different from the first and second positions, wherein the button system displays the third source image to the user.

13. An electronic device comprising a button system, the button system including:
an image sheet including first and second source images; and
a screen superimposed on the image sheet such that the image sheet is displayed to a user through the screen;
wherein the image sheet and the screen are relatively movable between a first position, wherein the button system displays the first source image to the user, and a second position, wherein the button system displays the second source image to the user.

14. The electronic device of claim 13 including a button activator underlying the image sheet.

15. The electronic device of claim 13 wherein the screen includes a lens screen adapted to convert the first and second source images as displayed to the user into first and second displayed images, the first and second displayed images being different from the first and second source images.

16. The electronic device of claim 15 wherein the lens screen is a lenticular lens.

17. The electronic device of claim 13 wherein the first and second positions correspond to first and second different operational modes of an associated electronic device.

18. The electronic device of claim 13 wherein the device is a wireless communications device.

19. The electronic device of claim 13 wherein the device is a handheld wireless communications device.

20. A method for providing a multi-face button using a button system including an image sheet and a screen superimposed on the image sheet such that the image sheet is displayed to a user through the screen, the image sheet including first and second source images, the method comprising:
relatively moving the image sheet and the screen from a first position, wherein the button system displays the first source image to the user, and a second position, wherein the button system displays the second source image to the user.

21. The method of claim 20 further including pressing the screen to actuate a button activator.

22. The method of claim 20 further including thereafter relatively moving the image sheet and the screen from the second position to the first position to again display the first source image to the user.

23. The method of claim 20 including switching from a first operational mode of an associated electronic device to a second, different operational mode of an associated electronic device.
